(19) United States
(12) Patent Application Publication
(10) Pub. No.: US 2024/0428425 A1
(43) Pub. Date: Dec. 26, 2024

(54) USING MOTION TRIGGERS TO REDUCE RESOURCE UTILIZATION FOR ATTRIBUTE SEARCH ON CAPTURED VIDEO DATA

(71) Applicant: Cisco Technology, Inc., San Jose, CA (US)

(72) Inventor: Amit Kumar Saha, Bangalore (IN)

(21) Appl. No.: 18/338,978

(22) Filed: Jun. 21, 2023

(51) Int. Cl. G06T 7/20; G06T 7/70

(52) U.S. Cl. CPC G06T 7/20; G06T 7/70; G06T 2207/30252

(57) ABSTRACT

Aspects of the present disclosure are directed to improving network resource utilization (at edge network devices) as well as at cloud-based processing components of a network, when performing attribute searches on video data captured at the edge devices of the network. In one aspect, a method includes detecting a motion event in a plurality of frames of video data captured using one or more edge devices, generating a motion blob for a subset of the plurality of frames associated with the motion event, processing the motion blob to generate one or more attributes, wherein each of the one or more attributes are identified once in the motion blob, and send the one or more attributes to a cloud processing component.

### TECHNICAL FIELD

The present disclosure relates to communication systems, and in particular, to solutions for improving efficiency of network resource usage when performing attribute search in video data captured at edge network devices.

### BACKGROUND

In the context of video analytics, attribute search is an additional filtering technique used on top of object-based search. For example, instead of simply searching for a “person,” in captured video frame(s), a desired search may be for a “person wearing a red-shirt”. In the former case, i.e., the case of a purely object-based search, the search result would contain all scenes in captured video with the person of interest present therein. This process can involve analyzing many frames and scenes, making it difficult to find the “the person of interest”.

Attribute search comes with its own set of implementation shortcomings, especially in the scenario where attributes are generated in real-time at an edge device of a network (e.g., a security camera). Some of such shortcomings can be associated with frequency of generating attributes. Should attributes be generated every second, or every minute, or every hour? Unless missing certain scenes is permitted, attributes for objects detected in the scene should be generated at a relatively high frequency, which depends on the nature of the scene viewed by the camera. A camera looking at a mostly static scene (e.g., a store during non-operational hours) may not need to generate any attributes since the camera may not see any person at all. The same camera looking at the same store during operation hours, would see a constant stream of people moving around in the store and would have to sample scenes at a very high frequency (minutes if not seconds). Doing so entails high use of processing and memory resources (either at the edge device or in a cloud component) to generate the attributes of interest, use of significant communication resources to transfer metadata from the edge device(s) to the cloud, and use of significant storage resources both at the edge device(s) and at the cloud for both short-term and long-term storage.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture according to some aspects of the present disclosure;

FIG. 1B illustrates an example fog computing architecture according to some aspects of the present disclosure;

FIG. 2 illustrates an example of a high-level network architecture according to some aspects of the present disclosure;

FIG. 3A illustrate an example of a high-level network architecture for video processing according to some aspects of the present disclosure;

FIG. 3B illustrates an example of a video review system according to some aspects of the present disclosure;

FIG. 4 illustrates an example architecture for attribute searching that may be implemented at an edge device according to some aspects of the present disclsoure;

FIG. 5 is an example flow chart of an attribute searching technique according to some aspects of the present disclosure;

FIG. 6 illustrates an example network device according to some aspects of the present disclosure; and

FIG. 7 shows an example of computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### OVERVIEW

Aspects of the present disclosure are directed to improving network resource utilization (at edge network devices) as well as at cloud-based processing components of a network, when performing attribute searches on video data captured at the edge devices of the network. As will be described in more detail, techniques disclosed herein can perform attributes searches on a subset of frames that are periodically captured by the edge device(s). The subset may be selected using a motion detection trigger, whereby frames in which motion is detected are analyzed for detection of attributes while remaining frames are ignored as far as conducting a specific attribute search is concerned.

In one aspect, a method includes detecting a motion event in a plurality of frames of video data captured using one or more edge devices, generating a motion blob for a subset of the plurality of frames associated with the motion event, processing the motion blob to generate one or more attributes, wherein each of the one or more attributes are identified once in the motion blob, and send the one or more attributes to a cloud processing component.

In another aspect, the method further includes capturing video data using the one or more edge devices at a given frequency, and detecting objects of interest in the video data, wherein the plurality of frames are frames in which the objects of interest are detected.

In another aspect, the objects of interest include people and vehicles.

In another aspect, the vehicles include one or more of cars, bikes, and flying objects.

In another aspect, the motion blob is a juxtaposition of one or more moving objects on top of a static background.

In another aspect, the one or more edge devices are one or more video cameras communicatively coupled to an enterprise network.

In another aspect, an attribute search is performed at the cloud processing component for an attribute of interest among the one or more attributes.

In one aspect, a network device includes one or more memories having computer-readable instructions stored therein and one or more processors. The one or more processors are configured to execute the computer-readable instructions to detect a motion event in a plurality of frames of video data captured at the network device, generate a motion blob for a subset of the plurality of frames associated with the motion event, process the motion blob to generate one or more attributes, wherein each of the one or more attributes are identified once in the motion blob, and send the one or more attributes to a cloud processing component.

In one aspect, one or more non-transitory computer-readable media include computer-readable instructions, which when executed by one or more processors of a edge network device, cause the edge network device to detect a motion event in a plurality of frames of video data, generate a motion blob for a subset of the plurality of frames associated with the motion event, process the motion blob to generate one or more attributes, wherein each of the one or more attributes are identified once in the motion blob, and send the one or more attributes to a cloud processing component.

### EXAMPLE EMBODIMENTS

The disclosed technology addresses the need in the art for improving resource utilization in a network when performing attribute searches on video data captured by various edge devices in the network such as video cameras.

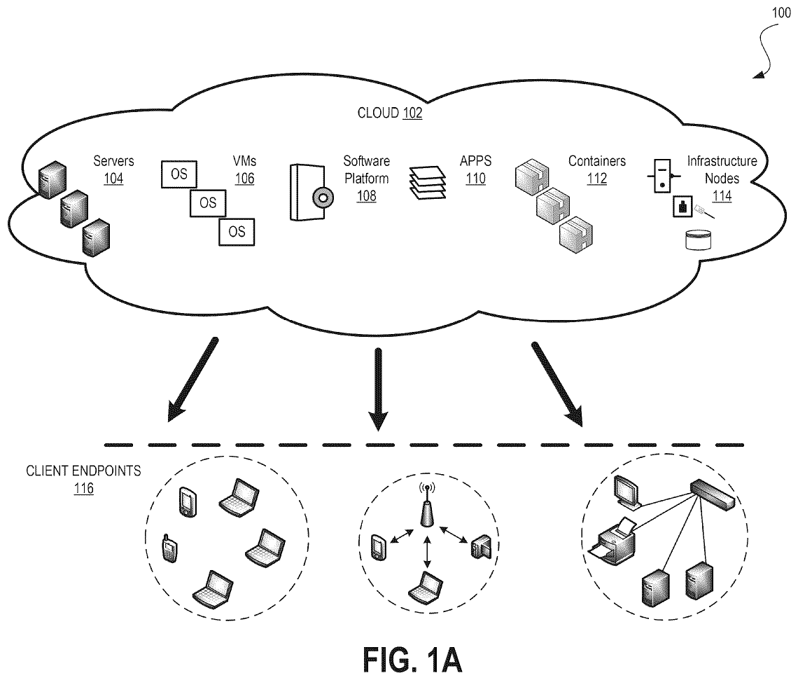

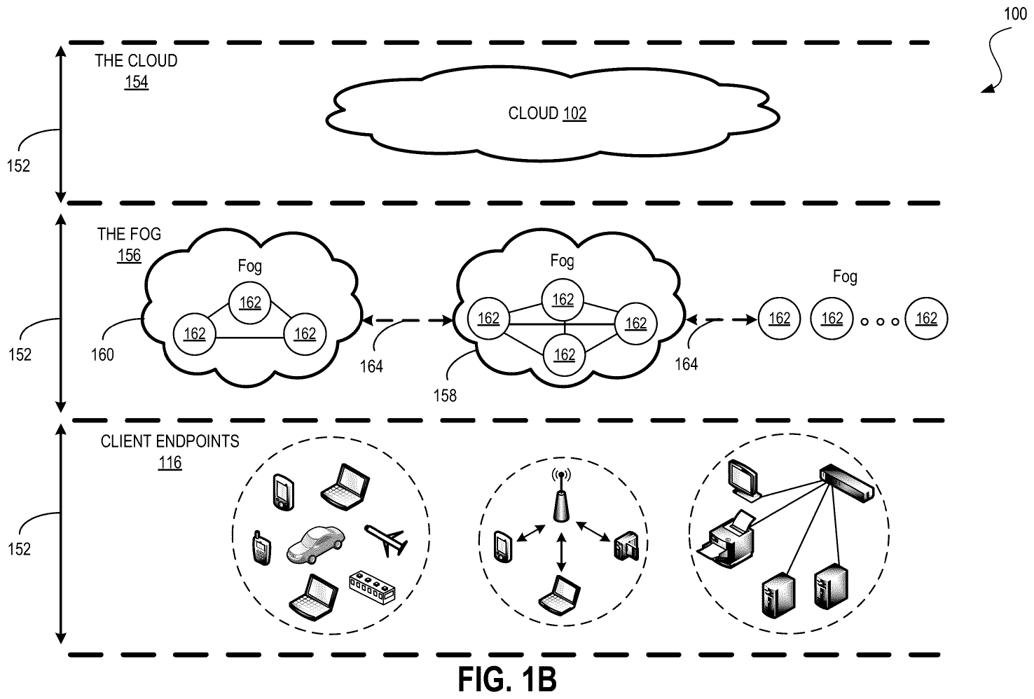

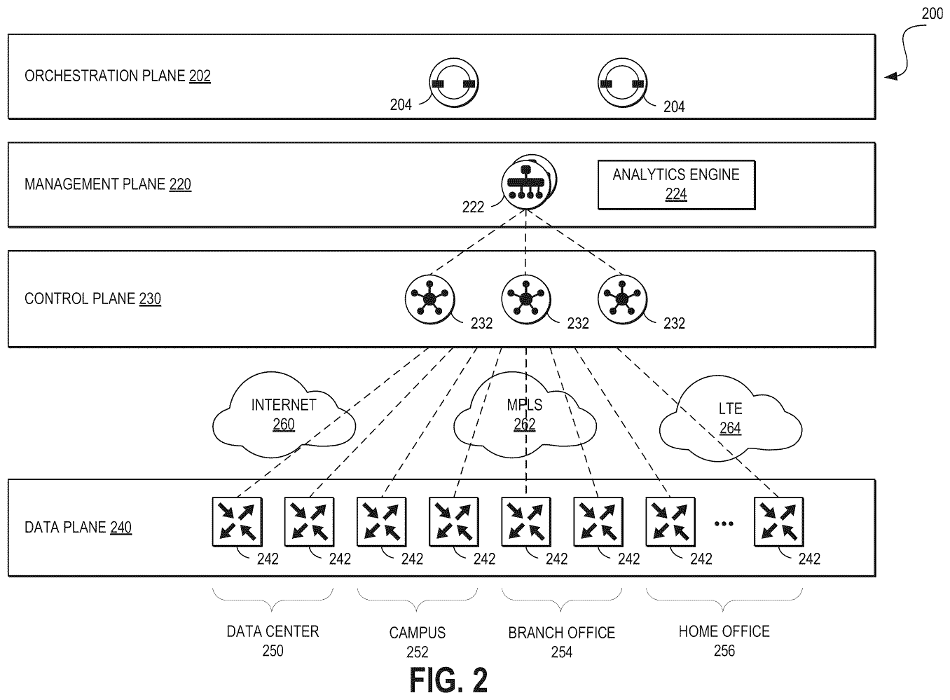

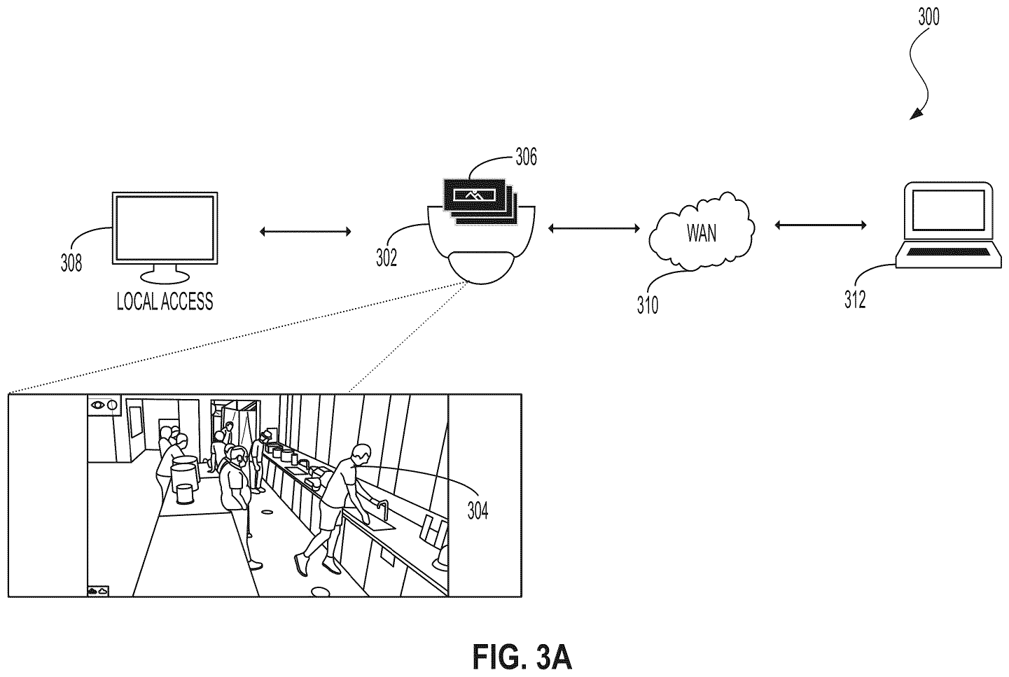

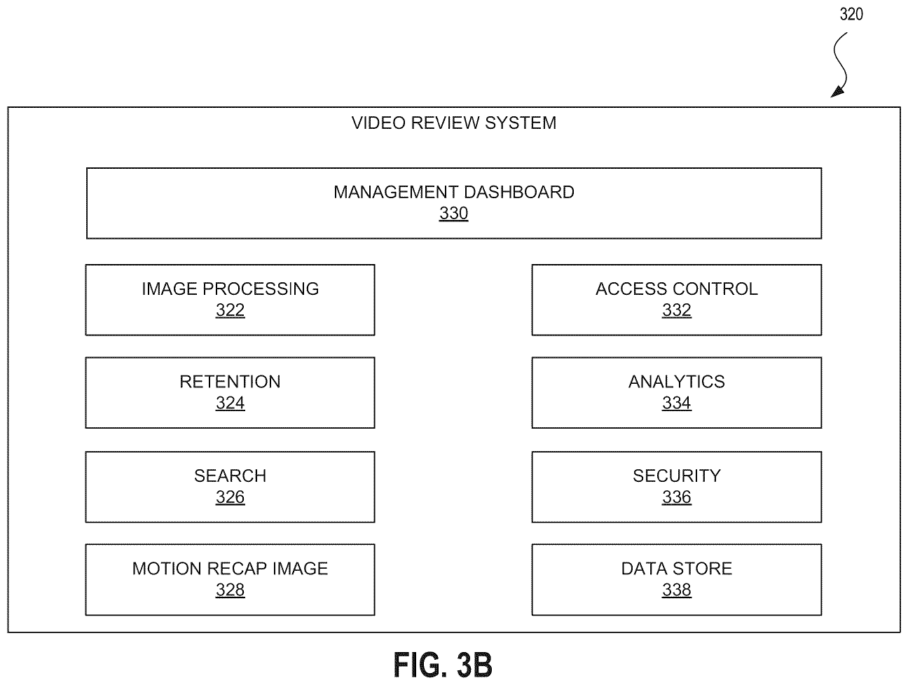

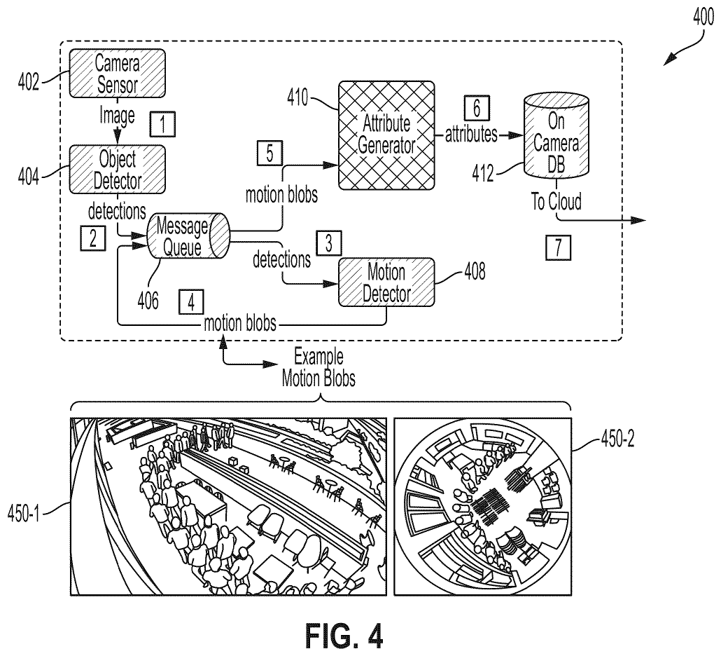

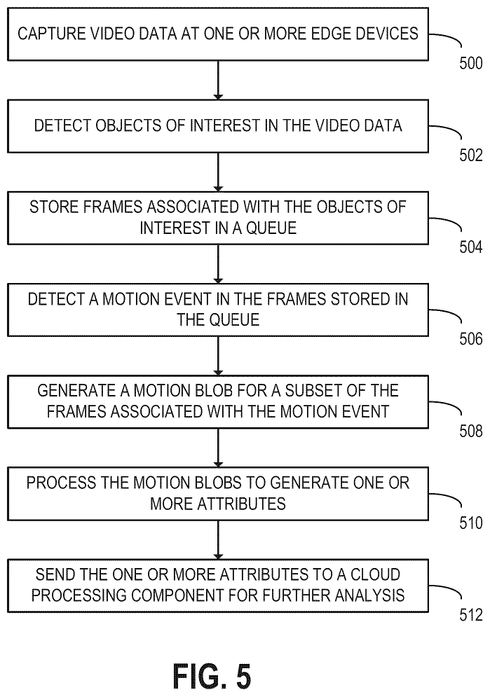

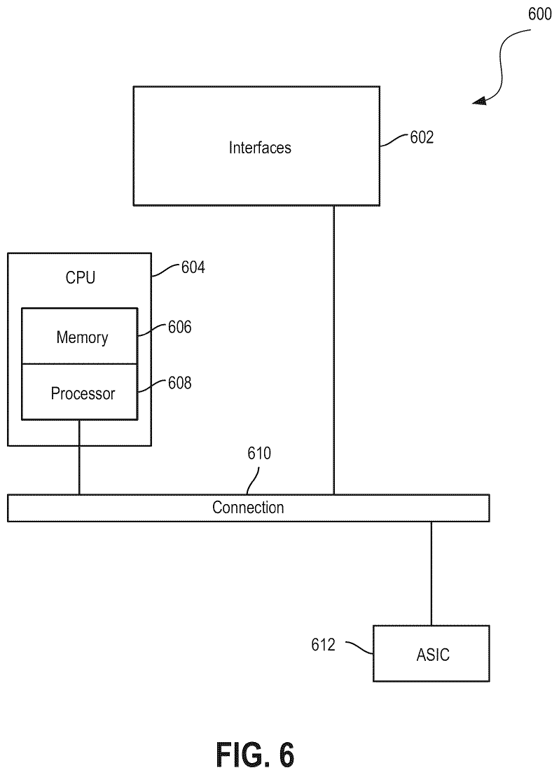

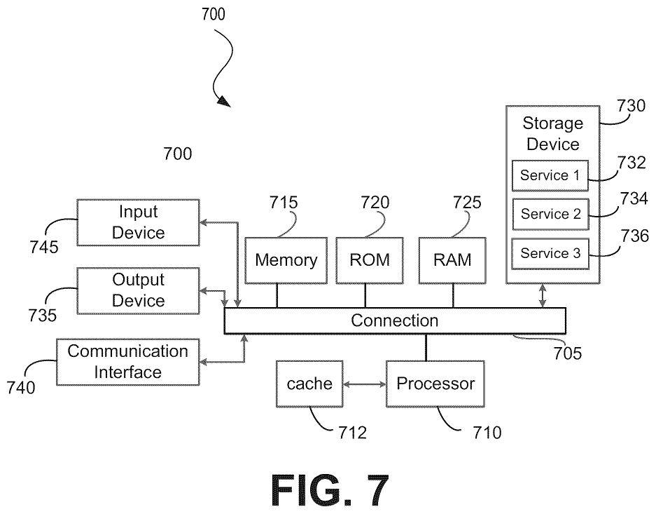

The disclosure begins with a description of example communication networks (e.g., enterprise networks) with reference to FIGS. 1A and 1B. Next, FIG. 2 which provides an example of a Software-Defined Wide Area Network (SD-WAN) is described. An example of a video processing system that can be deployed in example communication networks of FIGS. 1A-B and 2 will then be described with reference to FIGS. 3A and 3B. An example architecture for implementation at edge devices of a video processing system for attribute searching will then be described with reference to FIG. 4. The proposed attribute search techniques of the present disclosure will be described with reference to FIG. 5. Finally, example device and network system architectures will be described with reference to FIGS. 6 and 7.

FIG. 1A illustrates an example cloud computing architecture according to some aspects of the present disclosure. Architecture 100 can include cloud 102. Cloud 102 can be used to form part of a TCP connection or otherwise be accessed through the TCP connection. Specifically, cloud 102 can include an initiator or a receiver of a TCP connection and be utilized by the initiator or the receiver to transmit and/or receive data through the TCP connection. Cloud 102 can include one or more private clouds, public clouds, and/or hybrid clouds. Moreover, cloud 102 can include cloud elements 104-114. Cloud elements 104-114 can include, for example, servers 104, virtual machines (VMs) 106, one or more software platforms 108, applications or services 110, software containers 112, and infrastructure nodes 114. Infrastructure nodes 114 can include various types of nodes, such as compute nodes, storage nodes, network nodes, management systems, etc.

Cloud 102 can be used to provide various cloud computing services via cloud elements 104-114, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

Client endpoints 116 can connect with cloud 102 to obtain one or more specific services from cloud 102. Client endpoints 116 can communicate with elements 104-114 via one or more public networks (e.g., Internet), private networks, and/or hybrid networks (e.g., virtual private network). Client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates an example fog computing architecture according to some aspects of the present disclosure. Fog computing architecture 150 can be used to form part of a TCP connection or otherwise be accessed through the TCP connection. Specifically, the fog computing architecture can include an initiator or a receiver of a TCP connection and be utilized by the initiator or the receiver to transmit and/or receive data through the TCP connection. Fog computing architecture 150 can include cloud layer 154, which includes cloud 102 and any other cloud system or environment, and fog layer 156, which includes fog nodes 162. Client endpoints 116 can communicate with cloud layer 154 and/or fog layer 156. Architecture 150 can include one or more communication links 152 between cloud layer 154, fog layer 156, and client endpoints 116. Communications can flow up to cloud layer 154 and/or down to client endpoints 116.

Fog layer 156 or “the fog” provides the computation, storage and networking capabilities of traditional cloud networks, but closer to the endpoints. The fog can thus extend cloud 102 to be closer to client endpoints 116. Fog nodes 162 can be the physical implementation of fog networks. Moreover, fog nodes 162 can provide local or regional services and/or connectivity to client endpoints 116. As a result, traffic and/or data can be offloaded from cloud 102 to fog layer 156 (e.g., via fog nodes 162). Fog layer 156 can thus provide faster services and/or connectivity to client endpoints 116, with lower latency, as well as other advantages such as security benefits from keeping the data inside the local or regional network(s).

Fog nodes 162 can include any networked computing devices, such as servers, switches, routers, controllers, cameras, access points, gateways, etc. Moreover, fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. Fog instances 158, 158 can be local or regional clouds or networks. For example, fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with cloud layer 154 and/or endpoints 116. For example, a particular fog node can be placed in a vehicle, such as an aircraft or train, which can travel from one geographic location and/or logical location to a different geographic location and/or logical location. In this example, the particular fog node may connect to a particular physical and/or logical connection point with cloud 154 while located at the starting location and switch to a different physical and/or logical connection point with cloud 154 while located at the destination location. The particular fog node can thus move within particular clouds and/or fog instances and, therefore, serve endpoints from different locations at different times.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

FIG. 2 illustrates an example of a high-level network architecture according to some aspects of the present disclosure. An example of an implementation of network architecture 200 is the Cisco® SD-WAN architecture. However, one of ordinary skill in the art will understand that, for network architecture 200 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, network architecture 200 can comprise orchestration plane 202, management plane 220, control plane 230, and data plane 240. Orchestration plane 202 can 202 assist in the automatic on-boarding of edge network devices 242 (e.g., switches, routers, video cameras such as security cameras, etc.) in an overlay network. Orchestration plane 202 can include one or more physical or virtual network orchestrator appliances 204. Network orchestrator appliance(s) 204 can perform the initial authentication of the edge network devices 242 and orchestrate connectivity between devices of control plane 230 and data plane 240. In some embodiments, network orchestrator appliance(s) 204 can also enable communication of devices located behind Network Address Translation (NAT). In some embodiments, physical or virtual Cisco® SD-WAN vBond appliances can operate as the network orchestrator appliance(s) 204.

Management plane 220 can be responsible for central configuration and monitoring of a network. Management plane 220 can include one or more physical or virtual network management appliances 222 and analytics engine 224. In some embodiments, network management appliance(s) 222 can provide centralized management of the network via a graphical user interface to enable a user to monitor, configure, and maintain the edge network devices 242 and links (e.g., Internet transport network 260, MPLS network 262, 4G/LTE network 264) in an underlay and overlay network. Network management appliance(s) 222 can support multi-tenancy and enable centralized management of logically isolated networks associated with different entities (e.g., enterprises, divisions within enterprises, groups within divisions, etc.) using analytics engine 224. Alternatively or in addition, network management appliance(s) 222 can be a dedicated network management system for a single entity. In some embodiments, physical or virtual Cisco® SD-WAN vManage appliances can operate as network management appliance(s) 222.

Control plane 230 can build and maintain a network topology and make decisions on where traffic flows. Control plane 230 can include one or more physical or virtual network controller appliance(s) 232. Network controller appliance(s) 232 can establish secure connections to each network device 242 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, network controller appliance(s) 232 can operate as route reflectors. Network controller appliance(s) 232 can also orchestrate secure connectivity in data plane 240 between and among edge network devices 242. For example, in some embodiments, network controller appliance(s) 232 can distribute crypto key information among network device(s) 242. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as network controller appliance(s) 232.

Data plane 240 can be responsible for forwarding packets based on decisions from control plane 230. Data plane 240 can include edge network devices 242, which can be physical or virtual network devices. Edge network devices 242 can operate at the edges various network environments of an organization, such as in one or more data centers or colocation centers 250, campus networks 252, branch office networks 254, home office networks 256, and so forth, or in the cloud (e.g., Infrastructure as a Service (IaaS), Platform as a Service (PaaS), SaaS, and other cloud service provider networks). Edge network devices 242 can provide secure data plane connectivity among sites over one or more WAN transports, such as via one or more Internet transport networks 260 (e.g., Digital Subscriber Line (DSL), cable, etc.), MPLS networks 262 (or other private packet-switched network (e.g., Metro Ethernet, Frame Relay, Asynchronous Transfer Mode (ATM), etc.), mobile networks 264 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 242 can be responsible for traffic forwarding, security, encryption, quality of service (QoS), and routing (e.g., BGP, OSPF, etc.), among other tasks. In some embodiments, physical or virtual Cisco® SD-WAN vEdge routers can operate as edge network devices 242.

FIG. 3A illustrate an example of a high-level network architecture for video processing according to some aspects of the present disclosure. One of ordinary skill in the art will understand that, for network environment 300 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure. The example network architecture of FIG. 3A may be utilized within the broader network architectures of FIGS. 1A-B and 2.

In this example, network environment 300 can include one or more cameras 302 (e.g., video cameras, box cameras, dome cameras, Point Tilt Zoom (PTZ) cameras, bullet cameras, C-mount cameras, Internet Protocol (IP) cameras, Long-Term Evolution (LTE™) cameras, day/night cameras, thermal cameras, wide dynamic cameras, Closed-Circuit Television (CCTV) cameras, Network Video Recorders (NVRs), wireless cameras, smart cameras, indoor cameras, outdoor cameras, etc.) configured for recording data of a scene 304, including image data as a series of frames 306, audio data (not shown), and other sensor data (e.g., IR, thermal, motion, etc.) (not shown). In some embodiments, Cisco Meraki® MV series cameras may be deployed as the camera 302. Camera 302 may be any one of edge network devices 242 of FIG. 2, client endpoints 116, etc.

Network environment 300 also includes one or more computing devices 308 for providing local access to the data captured by camera 302. Computing devices 308 can be general purpose computing devices (e.g., servers, workstations, desktops, laptops, tablets, smart phones, etc.), wearable devices (smart watches, smart glasses or other smart head-mounted devices, smart ear pods or other smart in-ear, on-ear, or over-ear devices, etc.), televisions, digital displays, and any other electronic devices that are capable of connecting to or are integrated with camera 302 and incorporating input/output components to enable a user to locally access the cameras' data.

The network environment can also include Wide-Area Network (WAN) 310. In general, WAN 310 can connect geographically dispersed devices over long-distance communications links, such as common carrier telephone lines, optical light paths, synchronous optical networks (SONETs), synchronous digital hierarchy (SDH) links, Dense Wavelength Division Multiplexing (DWDM) links, and so forth. The WAN 310 may be a private network, such as a T1/E1, T3/E3, or other dedicated or leased line network; a Public Switched Telephone Network (PSTN), Integrated Services Digital Network (ISDN), or other circuit-switched network; Multi-Protocol Label Switching (MPLS), Ethernet WAN (also sometimes referred to as Metropolitan Ethernet or MetroE, Ethernet over MPLS or EoMPLS, Virtual Private Local Area Network (LAN) Service (VPLS), etc.), Frame Relay, Asynchronous Transfer Mode (ATM), or other packet-switched network; Very Small Aperture Terminal (VSAT) or other satellite network; and so forth.

WAN 310 can also be a public network, such as the Internet. The Internet can connect disparate networks throughout the world, providing global communication between devices on various networks. The devices may communicate over the network by exchanging discrete frames or packets of data according to predefined protocols, such as the Transmission Control Protocol/Internet Protocol (TCP/IP). Access to the Internet can be provided over a Digital Subscriber Line (DSL), cable, fiber, or wirelessly, such as via Municipal Wi-Fi, Worldwide Interoperability for Microwave Access (WiMAX), satellite Internet, or a cellular network (e.g., 3G, 4G, 5G, etc.), among other possibilities.

In some embodiments, camera 302 may use WAN 310 to connect to a cloud-based network management system to provide additional services, such as centralized management of network devices (e.g., routers, switches, access points, security appliances, gateways, etc.), Software-Defined WANs (SD-WANs) such as non-limiting example SW-WAN of FIG. 2, Wireless Local Area Network (WLANs), endpoints (e.g., computing devices, IP phones, etc.), and so forth. In some embodiments, the Cisco Meraki® platform may be used for the cloud-based management system. The Cisco Meraki® platform may be especially advantageous because it can also provide various advanced camera features, such as zero-touch configuration, cloud-augmented edge storage, security patching and software updates, video archival, video search indexing, and remote access (e.g., access by one or more computing devices 312 not locally connected to camera 302), among other functionalities.

FIG. 3B illustrates an example of a video review system according to some aspects of the present disclosure. In some embodiments, video review system 320 may be physically integrated with camera 302. In other embodiments, some or all of the functionality of one or more modules of video review system 320 may be additionally or alternatively implemented by computing devices 308 or 312, one or more computing devices of a cloud-based management system accessible via WAN 310, and the like. In this example, video review system 320 includes image processing module 322, data retention module 324, search module 326, motion recap image module 328, management dashboard 330, access control module 332, analytics module 334, security module 336, and data store 338.

Image processing module 322 can process image data of scene 304 captured by image sensors (not shown) of camera 302 to generate and store frames 306, such as in data store 338 and/or a remote data store accessible via WAN 310. In addition, image processing module 322 can analyze frames 306 to detect motion occurring within scene 304. As discussed in further detail below, motion can be detected by calculating a sum of absolute differences between frames 306 on a frame-by-frame basis. Motion can then be indexed based on various indicators, such as a timestamp, duration, and/or an intensity associated with the frame. Subsequently, data describing the motion (“motion metadata”) may be stored, such as in data store 338 and/or a remote data store accessible via WAN 310.

In some embodiments, image processing module 322 can analyze frames 306 locally to detect motion and index the video with the motion metadata and other metadata remotely. This hybrid-based approach can provide users maximum flexibility over how to store camera data. For example, data retention module 324 can enable users to select a video bit rate and frame rate to find the optimal balance between storage length and image quality. In some embodiments, data retention module 324 can also support cloud-augmented edge storage by storing a configurable amount of footage and motion metadata locally (e.g., the last 72 hours) before intelligently trimming stored video that may not include any motion. Data retention module 324 can also support scheduled recording to control if and when cameras 302 are recording. In addition, data retention module 324 can allow users to create schedule templates that may be applied to groups of cameras and to store only the data that may be needed. Recording can also be turned off altogether and live footage may be reviewed for selective privacy. Data retention module 324 can also provide real-time retention estimates for how long certain video data may be stored locally and/or remotely.

Search module 326 can be used to facilitate queries relating to video data, including motion search queries requesting for any of frames 306 or sets of the frames (e.g., sequences or clips) that may include motion. For example, search module 326 can enable a user to provide a motion search query (e.g., as input to cameras 302, the computing devices 308 or 312, etc.). The search query can be used to search data store 338 or transmitted for processing by a remote server accessible via WAN 310. As discussed in further detail below, the motion search query can include boundary conditions indicating a particular area or region within the frames in which motion events are to be searched. By permitting users to specify a particular “region of interest” for their motion search query, video data can be efficiently searched only for events occurring at indicated locations of interest, increasing the speed and efficiency of the search, as well as reducing overhead due to processing and other resources.

Motion recap image module 328 can generate one or more motion recap images from the search results or video clips responsive to the motion search query.

Management dashboard 330 can provide a user interface for configuring the cameras 302 and accessing camera data. In some embodiments, management dashboard 330 may be integrated with the user interface of a cloud-based management system, such as the Cisco Meraki® dashboard. Integration with the Cisco Meraki® dashboard may be especially advantageous because of some of the features the dashboard can provide, such as zero-touch configuration (e.g., using just serial numbers, an administrator can add devices to the dashboard and begin configuration even before the hardware arrives on site, users can stream video and configure cameras across multiple locations without having to configure an IP or installing a plugin, etc.), remote troubleshooting, centralized management, and the video wall.

Access control module 332 can provide differentiated access to users with granular controls appropriate for their particular roles. For example, access control module 332 can give a receptionist access to a video camera located at the front door but may not give him/her full camera configuration privileges, prevent security staff from changing network settings, limit views to selected cameras, restrict the export of video, and so forth. In some embodiments, access control module 332 can also support Security Assertion Markup Language (SAML).

Analytics module 334 can provide video review system 320 with various data science, computer vision, and machine learning capabilities, such as real-time and/or historical data analytics, heat maps, and person detection features. For example, the analytics module 334 can provide Message Queuing Telemetry Transport (MQTT) and Restful State Transfer (REST) Application Programming Interfaces (API) endpoints to enable organizations to integrate the edge-computing capabilities of camera 302 into the organizations' software systems, and provide the organizations with high-value (real-time and/or historical data) and insights without additional infrastructure. REST is a design pattern in which a server enables a client to access and interact with resources via Uniform Resource Identifiers (URIs) using a set of predefined stateless operations (referred to as endpoints).

MQTT is a client-server publish/subscribe messaging transport protocol that is lightweight, open, simple, and designed to be easy to implement. These characteristics can make it ideal for use in constrained environments, such as for communication in Machine-to-Machine (M2M) and Internet of Things (IoT) contexts where a small code footprint may be required or network bandwidth is at a premium. The MQTT protocol can run over TCP/IP, or over other network protocols that provide ordered, lossless, bi-directional connections.

Analytics module 334 can also generate heat maps. For example, analytics module 334 can use motion metadata to generate the heat maps to show an overview of historical motion, such as last week's worth of motion data, on a per-day or per-hour basis, to help users understand how a space is being used. Analytics module 334 can present a series of heat maps for each unit of time per selected resolution (e.g., 1 hour, 1 day, etc.). Areas of motion observed across the heat maps in this series can be given an absolute value relative to the total amount of motion. Analytics module 334 can display a range of colors to indicate motion in the area, such as from red to indicate a large amount of motion, green to indicate small amount of motion, and orange to yellow to indicate amounts of motion in between. Areas where very little or no motion may not be represented, as they may be insignificant compared to motion observed in other areas.

Person detection features can include the ability to detect persons in video data from a camera feed. For example, objects detected as persons may be enclosed by yellow boxes. Analytics module 334 can also generate histograms of people detected by camera 302 (e.g., per camera, per set of cameras, or for all cameras) and record statistics about how many persons entered or were present in a location at a specified time (e.g., per minute, hour, day, etc.), the hour or other time period that the location was most utilized, peak occupancy, total entrances, and so forth. Analytics module 334 can also identify anomalies when usage differs from historical trends.

Security module 336 can provide features such as Public Key Infrastructure (PKI) encryption for each camera 302 of video review system 320 and two-factor authentication for access to video review system 320. Security module 336 can also ensure that local video is encrypted by default to provide an additional layer of security that cannot be deactivated. In addition, security module 336 can automatically manage software updates and security patches according to scheduled maintenance windows.

Data store 338 can be used for saving video, motion metadata, and so forth. In some embodiments, data store 338 may be implemented using Solid State Devices (SSDs) on each camera 302. This can ensure that camera data continues to be recorded even when there is no network connectivity. In some embodiments, data store 338 may also be configured using a distributed architecture such that the storage of video review system 320 can scale with the addition of each camera 302 and to support high availability/failover protection.

As noted above, attribute searching comes with its own set of implementation shortcomings, especially in the scenario where attributes are generated in real-time at an edge device of a network (e.g., camera 302). Some of such shortcomings can be associated with frequency of generating attributes. Should attributes be generated every second, or every minute, or every hour? Unless missing certain scenes is permitted, attributes for objects detected in the scene should be generated at a relatively high frequency, which depends on the nature of the scene viewed by the camera. A camera looking at a mostly static scene (e.g., a store during non-operational hours) may not need to generate any attributes since the camera may not see any person at all. The same camera looking at the same store during operation hours, would see a constant stream of people moving around in the store and would have to sample scenes at a very high frequency (minutes if not seconds). Doing so entails high use of processing and memory resources (either at the edge device or in a cloud component) to generate the attributes of interest, use of significant communication resources to transfer metadata from the edge device(s) to the cloud, and use of significant storage resources both at the edge device(s) and at the cloud for both short-term and long-term storage. FIG. 4 illustrates an example architecture for attribute searching that may be implemented at an edge device according to some aspects of the present disclosure. Example architecture 400 may be implemented at an edge device such as camera 302 of FIG. 3A.

Aspects of the present disclosure are directed to improving network resource utilization (at edge network devices) as well as at cloud-based processing components of a network, when performing attribute searches on video data captured at the edge devices of the network. As will be described in more detail, techniques disclosed herein can perform attributes searches on a subset of frames that are periodically captured by the edge device(s). The subset may be selected using a motion detection trigger, whereby frames in which motion is detected are analyzed for detection of attributes while remaining frames are ignored as far as conducting a specific attribute search is concerned

FIG. 4 illustrates a number of logical components each performing one or more steps of techniques for attribute searching according to the present disclosure. However, it should be understood that these logical components may be computer-readable instructions stored on one or more memories, which are then executed by one or more processors on the edge device such as camera 302 to perform the corresponding one or more steps. FIG. 4 also illustrates a number of steps (1-7) that may be performed by various components of example architecture 400 for attribute searching.

Example architecture 400 can include one or more camera sensor(s) 402, an object detector 404, a message queue 406, a motion detector 408, an attribute generator 410 and an on-camera database 412.

At step 1, one or more camera sensors 402 may be used to capture video data (images) such as frames 306. One or more camera sensors 402 may be any known or to be developed sensor for capturing and recording video data. Video data can be captured in frames such as frames 306 at a configurable periodicity (e.g., every second, every minute, every hour, etc.).

At step 2, object detector 404 can detect one or more objects of interest in the video data. Objects of interest may be defined parameter such as people and vehicles. Vehicles can include cars, bikes, scooters, drones, etc. Edge devices may be trained to detect different types of objects of interest.

In one example, objects of interest that are detected are pushed to (stored temporarily) in message queue 406.

At step 3, motion detector 408 analyzes the frames in message queue 406 to detect motion. Any known or to be developed motion detection mechanism and technique may be utilized to detect motion in one or more frames, including but not limited to, example techniques described above with reference to FIG. 3B.

At step 4 and upon detecting motion, motion detector 408 may generate one or more motion blobs. Two non-limiting examples of motion blobs include motion blob 450-1 and 450-2 in FIG. 4. Motion blobs include juxtaposition of one or more objections during their movement over a static background. In other words, for any given movement, all frames that correspond to the motion at hand, are combined into one in which discrete progression of such movement over the statis background is shown.

At step 5, the motion blobs (e.g., motion blobs 450-1 and 450-2 are read by attribute generator 410.

At step 6, attribute generator 410 generates one or more attributes. For example, an attribute can be a color of a jacket that a human is wearing or any other wearable and/or holdable item. An attribute can be a type or a color of a vehicle detected in a given motion blob. Any other definable feature in a motion blob can be an attribute that attribute generator 410 can generate.

In one example, attribute generator 410 may generate each attribute in each motion blob only once. Even though the same object is repeated multiple times in the blob (e.g., as shown in example motion blobs 450-1 and 450-2), the attribute is generated only once since there is unique identification for each of the objects in the blob. At step 6, attribute generator 410 writes the generated attributes into a local database at the edge device such as on-camera database 412.

At step 7, the stored attributes may be sent to a cloud processing component such as video review system 320 that may be implemented on a server in the cloud (e.g., cloud 102), for further processing. For instance, such further processing can include an attribute search from among attributes generated and transmitted to the cloud by camera 302. Any other processing including, but not limited to, different examples of image/video processing described above with reference to FIG. 3B may be performed.

FIG. 5 is an example flow chart of an attribute searching technique according to some aspects of the present disclosure. Example technique of FIG. 5 will be described from the perspective of an edge device (e.g., camera 302). It should be understood that such edge device may have one or more memories having computer-readable instructions stored therein (e.g., implementing logical components described with reference to example architecture 400 of FIG. 4), which can then be implemented by one or more processors of the edge device to implement steps of FIG. 5. In another example, process of FIG. 5 may be implemented at a cloud processing component in cloud 102. Furthermore, in describing FIG. 5, references may be made to FIGS. 3A-B and 4.

At step 500, camera 302 (an edge device) may capture video data of one or more scenes. While here, video data capturing is described as performed by a single camera 302, the present disclosure is not limited thereto. For instance, multiple network-connected cameras such as camera 302 may perform the video data capturing process (individually at different times and/or simultaneously).

Video data may be captured as frames such as frames 306 of FIG. 3A. In one example, video data may be captured periodically with a configurable periodicity (e.g., one frame per second, 10 frames per second, 1 frame per minute, 10 frames per minute, 1 frame per hour, 20 frames per hours, etc.). The number of frames per time period (e.g., seconds, minutes, hours, days, etc.) and the time period are configurable parameters that may be adjusted and specified as needed/desired.

At step 502, camera 302 may detect objects of interest in the video data captured at step 500. Accordingly, a plurality of frames in which objects of interest are identified may be determined.

Objects of interest can be defined as vehicles and persons. In the context of the present disclosure a vehicle can include any moving and man-made object including, but not limited to, cars, bikes, scooters, buses, trains, flying objects such as drones, robots, etc. Furthermore, in the context of the present disclosure, a person may be defined as human beings, animals, plants, etc.

At step 504, camera 302 may store the frames (the plurality of frames) associated with the objects of interest in a queue such as message queue 406 of FIG. 4.

At step 506, camera 302 may detect a motion event in the frames stored in the message queue. Any known or to be developed motion detection technique for detecting motion in captured still and/or moving frames may be utilized (e.g., motion detection technique described above with reference to FIG. 3B). A motion event may be detected across a subset of the plurality of frames in which the objects of interest are detected and stored in the queue.

At step 508, camera 302 may generate a motion blob using a subset of the plurality of frames in which a motion event is detected. Any known or to be developed technique for generating a motion blob may be utilized. Non-limiting examples of motion blobs are shown and described above with reference to FIG. 4 (e.g., motion blobs 450-1 and 450-2). As noted, a motion blob can be a juxtaposition of one or more moving objects (e.g., a human walking or a vehicle moving) over a static background. A single motion blob can be created using multiple frames.

At step 510, camera 302 may generate one or more attributes in each motion blob generated at step 508. Non-limiting examples of attributes can include a color of a jacket that a human is wearing or any other wearable and/or holdable item. An attribute can be a type or a color of a vehicle detected in a given motion blob. Any other definable feature in a motion blob can be an attribute that camera 302 can generate.

As described with reference to FIG. 4, each attribute in each motion blob can be generated only once. Even though the same object is repeated multiple times in the blob (e.g., as shown in example motion blobs 450-1 and 450-2), the attribute is generated only once since there is unique identification for each of the objects in the blob.

In one example, generated attributes may be stored in a local database at camera 302 such as database 412 as described with reference to FIG. 4.

At step 512, the generated attributes may be sent (transmitted) to a cloud processing component in cloud (e.g., cloud 102). Such transmission may be over any known or to be developed wired and/or wireless medium and using any known or to be developed communication scheme.

Once transmitted over to a cloud processing component, further processing may be performed at the cloud processing component. Such processing may include searching for one or more of generated attributes among the attributes sent to the cloud processing component (e.g., a person wearing a red shirt). Such further processing can be performed by video review system 320.

In another example such further processing of generated attributes can be performed at the camera 302 itself (e.g., when video review system 320 is implemented at camera 302).

Attribute searching techniques presented in this disclosure address issues with network resource utilization and provide improvements in use thereof. By generating attributes upon motion event detection, CPU and memory usage on edge network devices and/or at the cloud are significantly improved, less metadata needs to be transmitted over the network hence conserving transmission resources in the network, and storage resource usage can also be improved at both edge network devices and in the cloud since less data are stored and analyzed for attribute generation.

FIG. 6 illustrates an example network device according to some aspects of the present disclosure. Example network device 600 may be suitable for performing switching, routing, load balancing, and other networking operations. Example network device 600 can be implemented as switches, routers, nodes, metadata servers, load balancers, client devices (e.g., camera 302, a cloud processing component described with reference to FIGS. 4 and 5), and so forth.

Network device 600 includes central processing unit (CPU) 604, interfaces 602, and bus 610 (e.g., a PCI bus). When acting under the control of appropriate software or firmware, CPU 604 is responsible for executing packet management, error detection, and/or routing functions. CPU 604 preferably accomplishes all these functions under the control of software including an operating system and any appropriate applications software. CPU 604 may include one or more processors 608, such as a processor from the INTEL X86 family of microprocessors. In some cases, processor 608 can be specially designed hardware for controlling the operations of network device 600. In some cases, a memory 606 (e.g., non-volatile RAM, ROM, etc.) also forms part of CPU 604. However, there are many different ways in which memory could be coupled to the system.

Interfaces 602 are typically provided as modular interface cards (sometimes referred to as “line cards”). Generally, they control the sending and receiving of data packets over the network and sometimes support other peripherals used with network device 600. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 604) to efficiently perform routing computations, network diagnostics, security functions, etc.

Although the system shown in FIG. 6 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with network device 600.

Regardless of the network device's configuration, it may employ one or more memories or memory modules (including memory 606) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 606 could also hold various software containers and virtualized execution environments and data.

Network device 600 can also include an application-specific integrated circuit (ASIC) 612, which can be configured to perform routing and/or switching operations. ASIC 612 can communicate with other components in network device 600 via bus 610, to exchange data and signals and coordinate various types of operations by network device 600, such as routing, switching, and/or data storage operations, for example.

FIG. 7 shows an example of computing system according to some aspects of the present disclosure. Computing system 700 can be used to implement any one or more components of a network such as example networks of FIGS. 1A-B, 2, 3A-B, and 4 including camera 302, a cloud processing component described with reference to FIGS. 4 and 5, etc. Components of computing system 700 may be in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement, and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Storage device 730 can include software services, servers, services, etc., that when the code that defines such software is executed by processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A method comprising: detecting a motion event in a plurality of frames of video data captured using one or more edge devices; generating a motion blob for a subset of the plurality of frames associated with the motion event; processing the motion blob to generate one or more attributes, wherein each of the one or more attributes are identified once in the motion blob; and send the one or more attributes to a cloud processing component.
Aspect 2. The method of Aspect 1, further comprising: capturing video data using the one or more edge devices at a given frequency; detecting objects of interest in the video data, wherein the plurality of frames are frames in which the objects of interest are detected.
Aspect 3. The method of any of Aspects 1 to 2, wherein the objects of interest include people and vehicles.
Aspect 4. The method of any of Aspects 1 to 3, wherein the vehicles include one or more of cars, bikes, and flying objects.
Aspect 5. The method of any of Aspects 1 to 4, wherein the motion blob is a juxtaposition of one or more moving objects on top of a static background.
Aspect 6. The method of any of Aspects 1 to 5, wherein the one or more edge devices are one or more video cameras communicatively coupled to an enterprise network.
Aspect 7. The method of any of Aspects 1 to 6, wherein an attribute search is performed at the cloud processing component for an attribute of interest among the one or more attributes.
Aspect 8. A network device comprising: one or more memories having computer-readable instructions stored therein; and one or more processors configured to execute the computer-readable instructions to: detect a motion event in a plurality of frames of video data captured at the network device; generate a motion blob for a subset of the plurality of frames associated with the motion event; process the motion blob to generate one or more attributes, wherein each of the one or more attributes are identified once in the motion blob; and send the one or more attributes to a cloud processing component.
Aspect 9. The network device of Aspect 8, wherein the one or more processors are configured to execute the computer-readable instructions to: capture video data at a given frequency; detect objects of interest in the video data, wherein the plurality of frames are frames in which the objects of interest are detected.
Aspect 10. The network device of any of Aspects 8 to 9, wherein the objects of interest include people and vehicles.
Aspect 11. The network device of any of Aspects 8 to 10, wherein the vehicles include one or more of cars, bikes, and flying objects.
Aspect 12. The network device of any of Aspects 8 to 11, wherein the motion blob is a juxtaposition of one or more moving objects on top of a static background.
Aspect 13. The network device of any of Aspects 8 to 12, wherein the network device is a video camera communicatively coupled to an enterprise network.
Aspect 14. The network device of any of Aspects 8 to 13, wherein an attribute search is performed at the cloud processing component for an attribute of interest among the one or more attributes.
Aspect 15. One or more non-transitory computer-readable media comprising computer-readable instructions, which when executed by one or more processors of a edge network device, cause the edge network devices to: detect a motion event in a plurality of frames of video data; generate a motion blob for a subset of the plurality of frames associated with the motion event; process the motion blob to generate one or more attributes, wherein each of the one or more attributes are identified once in the motion blob; and send the one or more attributes to a cloud processing component.
Aspect 16. The one or more non-transitory computer-readable media of Aspect 15, wherein the execution of the computer-readable instructions further cause the edge network devices to: capture video data at a given frequency; detect objects of interest in the video data, wherein the plurality of frames are frames in which the objects of interest are detected.
Aspect 17. The one or more non-transitory computer-readable media of any of Aspects 15 to 16, wherein the objects of interest include people and vehicles, and the vehicles include one or more of cars, bikes, and flying objects.
Aspect 18. The one or more non-transitory computer-readable media of any of Aspects 15 to 17, wherein the motion blob is a juxtaposition of one or more moving objects on top of a static background.
Aspect 19. The one or more non-transitory computer-readable media of any of Aspects 15 to 18 wherein the edge device is a video camera communicatively coupled to an enterprise network.
Aspect 20. The one or more non-transitory computer-readable media of any of Aspects 15 to 19, wherein an attribute search is performed at the cloud processing component for an attribute of interest among the one or more attributes.

What is claimed is:

1. A method comprising:
detecting a motion event in a plurality of frames of video data captured using one or more edge devices;
generating a motion blob for a subset of the plurality of frames associated with the motion event;
processing the motion blob to generate one or more attributes, wherein each of the one or more attributes are identified once in the motion blob; and
send the one or more attributes to a cloud processing component.

2. The method of claim 1, further comprising:
capturing video data using the one or more edge devices at a given frequency; and
detecting objects of interest in the video data, wherein the plurality of frames are frames in which the objects of interest are detected.

3. The method of claim 2, wherein the objects of interest include people and vehicles.

4. The method of claim 3, wherein the vehicles include one or more of cars, bikes, and flying objects.

5. The method of claim 1, wherein the motion blob is a juxtaposition of one or more moving objects on top of a static background.

6. The method of claim 1, wherein the one or more edge devices are one or more video cameras communicatively coupled to an enterprise network.

7. The method of claim 1, wherein an attribute search is performed at the cloud processing component for an attribute of interest among the one or more attributes.

8. A network device comprising:
one or more memories having computer-readable instructions stored therein; and
one or more processors configured to execute the computer-readable instructions to:
detect a motion event in a plurality of frames of video data captured at the network device;
generate a motion blob for a subset of the plurality of frames associated with the motion event;
process the motion blob to generate one or more attributes, wherein each of the one or more attributes are identified once in the motion blob; and
send the one or more attributes to a cloud processing component.

9. The network device of claim 8, wherein the one or more processors are configured to execute the computer-readable instructions to:
capture video data at a given frequency; and
detect objects of interest in the video data, wherein the plurality of frames are frames in which the objects of interest are detected.

10. The network device of claim 9, wherein the objects of interest include people and vehicles.

11. The network device of claim 10, wherein the vehicles include one or more of cars, bikes, and flying objects.

12. The network device of claim 8, wherein the motion blob is a juxtaposition of one or more moving objects on top of a static background.

13. The network device of claim 8, wherein the network device is a video camera communicatively coupled to an enterprise network.

14. The network device of claim 8, wherein an attribute search is performed at the cloud processing component for an attribute of interest among the one or more attributes.

15. One or more non-transitory computer-readable media comprising computer-readable instructions, which when executed by one or more processors of a edge network device, cause the edge network devices to:
detect a motion event in a plurality of frames of video data;
generate a motion blob for a subset of the plurality of frames associated with the motion event;
process the motion blob to generate one or more attributes, wherein each of the one or more attributes are identified once in the motion blob; and
send the one or more attributes to a cloud processing component.

16. The one or more non-transitory computer-readable media of claim 15, wherein the execution of the computer-readable instructions further cause the edge network devices to:
capture video data at a given frequency; and
detect objects of interest in the video data, wherein the plurality of frames are frames in which the objects of interest are detected.

17. The one or more non-transitory computer-readable media of claim 16, wherein
the objects of interest include people and vehicles, and
the vehicles include one or more of cars, bikes, and flying objects.

18. The one or more non-transitory computer-readable media of claim 15, wherein the motion blob is a juxtaposition of one or more moving objects on top of a static background.

19. The one or more non-transitory computer-readable media of claim 15 wherein the edge device is a video camera communicatively coupled to an enterprise network.

20. The one or more non-transitory computer-readable media of claim 15, wherein an attribute search is performed at the cloud processing component for an attribute of interest among the one or more attributes.
